(19) United States
(12) Patent Application Publication
(10) Pub. No.: US 2026/0311388 A1
(43) Pub. Date: Oct. 8, 2026

(54) GENERATION AND LAYOUT OF DIAGRAMS

(71) Applicant: Lucid Software, Inc., South Jordan, UT (US)

(72) Inventors: Tyler Davis, South Jordan, UT (US); John Harrison, South Jordan, UT (US); Houston Trueblood, South Jordan, UT (US); Benjamin Hatch, South Jordan, UT (US); Abhinav Thukral, South Jordan, UT (US); James Moore, South Jordan, UT (US)

(21) Appl. No.: 19/631,921

(22) Filed: Mar. 27, 2026

Related U.S. Application Data
(60) Provisional application No. 63/782,551, filed on Apr. 2, 2025.

(51) Int. Cl. G06T 11/26; G06T 3/40; G06T 11/60

(52) U.S. Cl. CPC G06T 11/26; G06T 3/40; G06T 11/60

(57) ABSTRACT

An example embodiment includes a method to facilitate placement of graphical objects within a container. The method includes generating the container. The container may include a cell formatting for positioning graphical objects within the container. The method may also include associating a graphical object with a cell of the container. In addition, the method may include setting a size of the cell based on a size of the graphical object. Further, the method may include positioning the graphical object within the cell such that a center point of the graphical object and a center point of the cell at least partially overlap.

### CROSS-REFERENCE TO RELATED APPLICATION

This patent application claims the benefit of and priority to U.S. Provisional App. No. 63/782,551 filed Apr. 2, 2025 titled “GENERATION AND LAYOUT OF DIAGRAMS,” which is incorporated in the present disclosure by reference in its entirety.

### FIELD

The embodiments discussed herein are related to generation and layout of diagrams.

### BACKGROUND

Unless otherwise indicated herein, the materials described herein are not prior art to the claims in the present application and are not admitted to be prior art by inclusion in this section.

A system may generate a diagram within a canvas based on input data. The input data may include information representative of a process, structure, or other type of information. The diagram may include graphical objects that are representative of portions of the process, structure, or other type of information. In addition, the graphical objects may be arranged in accordance with the input data. Further, the diagram may include connectors connecting various graphical objects to indicate a flow or interconnectedness of the graphical objects within the diagram.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

An example embodiment may include a method to facilitate placement of graphical objects within a container. The method includes generating the container. The container may include a cell formatting for positioning graphical objects within the container. The method may also include associating a graphical object with a cell of the container. In addition, the method may include setting a size of the cell based on a size of the graphical object. Further, the method may include positioning the graphical object within the cell such that a center point of the graphical object and a center point of the cell at least partially overlap.

Another example embodiment may include a method to facilitate routing of connectors between graphical objects. The method may include receiving a connection list identifying a plurality of proxy objects and identifying connections to be made between instances of the proxy objects. Each of the proxy objects may correspond to a different graphical object to be included in a diagram in a canvas. The method may also include generating a proxy diagram including the plurality of proxy objects arranged in an order within a grid based on the connection list. In addition, the method may include routing a proxy connector between a first proxy object and a second proxy object to form a spine path within the grid. The first proxy object may correspond to a first graphical object and the second proxy object may correspond to a second graphical object. Further, the method may include generating the diagram within the canvas based on the proxy diagram such that a connector is routed between the first graphical object and the second graphical object based on the proxy connector routed between the first proxy object and the second proxy object.

Another example embodiment may include a method to facilitate placement of graphical objects within a diagram. The method may include receiving a plurality of graphical objects that are to form a diagram. The method may also include identifying a first graphical object that corresponds to a start point of the diagram and a second graphical object that corresponds to an end point of the diagram. In addition, the method may include identifying a spine path between the first graphical object and the second graphical object. The spine path may include a number of graphical objects to create a path from the first graphical object to the second graphical object. Further, the method may include generating the diagram comprising the plurality of graphical objects and a connector arranged in accordance with the spine path.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a block diagram of an example operating environment for a computing device configured to generate a diagram or a proxy diagram within a canvas;

FIG. 2 illustrates an example container that may be implemented in the canvas of FIG. 1;

FIGS. 3A-3G illustrate an example of the canvas of FIG. 1 including graphical objects and an example container;

FIGS. 4A-4C illustrate an example container including graphical objects that may be implemented in the canvas of FIG. 1 including graphical objects and an example container;

FIGS. 5A and 5B illustrate an example container that may be implemented in the canvas of FIG. 1;

FIG. 6 illustrates an example of the diagram of FIG. 1;

FIGS. 7A-7E illustrate example proxy diagrams;

FIG. 8 illustrates a flowchart of an example method to facilitate placement of graphical objects within a container;

FIG. 9 illustrates a flowchart of an example method to facilitate routing of connectors between graphical objects;

FIG. 10 illustrates a flowchart of an example method to facilitate placement of graphical objects within a diagram; and

FIG. 11 is a block diagram illustrating an example computing device that is arranged to facilitate generation of a proxy diagram or a diagram, all arranged in accordance with at least one embodiment described herein.

### DETAILED DESCRIPTION OF SOME EXAMPLE EMBODIMENTS

The input data may include computer code, artificial intelligence (AI) generated text, a markup document, manual user input, a text-based document, application programming interface (API) call generated text, any other appropriate type of data, or some combination thereof. The computer code may include information in a programming language such as python, JavaScript, Java, TypeScript, or any other appropriate programming language. The AI generated text may include output of a large language model or output of any other appropriate text generating AI model. The markup document may include a hypertext markup language (HTML) document, an extensible markup language (XML) document, a markdown document, a mermaid markdown document, a plant unified modeling language (UML) document, a LaTeX document, or any other appropriate type of markup document. The manual user input may include a drag/drop input, a click input, an audible input, an image input, or any other appropriate type of manual user input. The text-based document may include a separated values (SV) document (e.g., a comma SV document, a tab SV document, or a space SV document), a JavaScript object notation (JSON) document, a parquet document, an optimized row columnar (ORC) document, an excel (XLS) document, a Word (DOC) document, a portable document format (PDF) document, or any other appropriate type of document. The API call generated text may include responses from web services, cloud-based services, database queries, remote procedure calls, representational state transfer (REST) API responses, simple object access protocol (SOAP) responses, GraphQL responses, webhook notifications, third-party service integrations, streaming API data, batch processing results, or any other appropriate type of text generated through programmatic interfaces.

In some embodiments, the input data may be representative of a process such as a business process, a workflow, a sequence of steps, a computer program, or any other appropriate process. Additionally or alternatively, the input data may be representative of a structure or another arrangement such as a circuit layout, an organization hierarchy, a network diagram, or any other appropriate structure or arrangement. The diagram may be generated to illustrate or show the process or the structure in a visual manner. The diagram may include a swim lane diagram, an entity relationship diagram (ERD), a frame diagram, or any other appropriate type of diagram.

A diagram system may generate the diagram based on one or a combination of some of the types of the input data. For example, the diagram system may be designed to generate the diagram based only on manual user input. As another example, the diagram system may be designed to generate the diagram based on text-based documents and the manual user input. When the input data includes a different type than what the diagram system is designed for, the diagram system may become cumbersome to use or time consuming to operate and/or may generate instances of the diagram that are consistent or uniform. For example, when the input data includes a different type than what the diagram system is designed for, the diagram system may cause a user to manually place graphical objects and/or connectors in the diagram. As another example, the diagram system may generate different instances of the diagram that include different spacing, various graphical objects in different locations, or connectors extending between different graphical objects.

Accordingly, the diagram system may limit the types of input data that may be used to generate the diagram as intended, may introduce errors or inconsistencies between different instances of the diagram, or may generate the different instances of the diagram with inconsistent layouts or spacing.

The diagram system may generate the graphical objects in the diagram in accordance with a scale ratio that is different than a scale ratio of cells of the diagram. For example, the diagram system may generate a graphical object with a scale ratio of eighty pixels by sixty pixels, but the cells of the diagram may include a scale ratio of twenty pixels by twenty pixels (e.g., a finer scale ratio than the graphical object). In addition, the diagram system may snap the graphical objects to corners of the cells of the diagram. The graphical objects snapping to the corners of the cells of the diagram along with the difference in scale ratio of the graphical objects and the cells may cause the graphical objects to not be aligned with each other in the diagram. Additionally, the graphical objects snapping to the corners of the cells of the diagram along with the difference in scale ratio of the graphical objects and the cells may cause the diagram to include inconsistent spacing between the graphical objects.

The graphical objects not being aligned with each other in the diagram may cause routing of connectors to be cumbersome and cause the connectors to include unnecessary turns, bends, or other breaks. In addition, the graphical objects not being aligned with each other or the connectors including turns, bends, or other breaks may cause the diagram to be confusing to a user.

When routing of the connectors is to be changed or revised, the diagram system may have the user manually move (e.g., re-route) the connectors. Manually moving the connectors may cause the connectors to cross other connectors, graphical objects, or both. Additionally, manually moving individual connectors may be time consuming. For example, manually moving individual connectors may be time consuming when multiple connectors are to be moved. As another example, manually moving the connectors may necessitate also moving graphical objects to create a path for the connectors. Manually moving the connectors may cause issues when a size of graphical objects change. For example, when the size of a graphical object is increased, the graphical object may overlap connectors and the user may manually move the connector to eliminate the overlap.

Accordingly, generating the diagram from multiple types of input data may cause the diagram to include errors, inconsistently spaced or aligned graphical objects, or require complex operations to move the connectors. Therefore, there is a need for systems and methods that can generate diagrams from multiple types of input data without errors, with consistently spaced and aligned graphical objects, and without complex operations to move the connectors.

The present disclosure provides techniques and systems to generate a diagram based on multiple types of input data without introducing errors. In addition, the present disclosure provides techniques and systems to generate the diagram with consistently spaced and aligned graphical objects without complex operations to move the connectors.

Some embodiments may include a computing device that generates a universal document. For example, the computing device may convert the different types of input data to a universal markup language for the universal document. As another example, the computing device may convert results of or the actual manual user input into text-based input data to be included in the universal document. As another example, the computing device may add contents of the text-based document (e.g., a SV document or an AI generated text document) to the universal document. The computing device may generate the diagram based on the universal document.

The computing device may place the graphical objects within a container in a digital canvas (referred to in the present disclosure as “canvas”). The computing device may generate the container. The container may include a cell formatting for positioning the graphical objects within the container. The computing device may also associate graphical objects with different cells of the container. In addition, the computing device may set a size of the different cells based on a size of the corresponding graphical objects. Further, the computing device may position the graphical objects within the corresponding cells such that center points of the graphical objects and center points of the corresponding cells at least partially overlap. In some embodiments, the diagram may include the arrangement of the graphical objects within the container.

The computing device may place the graphical objects within the diagram. The computing device may identify a first graphical object as corresponding to a start point of the diagram. The computing device may also identify a second graphical object as corresponding to an end point of the diagram. In addition, the computing device may identify a spine path between the first graphical object and the second graphical object. The spine path may include a number of graphical objects to create a path from the first graphical object to the second graphical object in the diagram. Further, the computing device may generate the diagram with the graphical objects and connectors arranged in accordance with the spine path.

The computing device may route connectors between the graphical objects in the diagram. The computing device may receive a connection list. The connection list may identify proxy objects and connections to be made between instances of the proxy objects. Each of the proxy objects may correspond to a different graphical object to be included in the diagram. The computing device may also generate a proxy diagram that includes the proxy objects arranged in an order within a grid based on the connection list. In addition, the computing device may route proxy connectors between at least some of the proxy objects to form the spine path within the grid. Further, the computing device may generate the diagram based on the proxy diagram such that connectors are routed between the graphical objects corresponding to the proxy objects that form the spine path.

The present disclosure provides techniques and systems to generate the diagram based on any combination of manual data, text data, or computer code data. In particular, the present disclosure provides techniques and systems to generate the diagram based on any combination of the input data because it generates the proxy diagram based on the connection list in the input data, identifies the spine path of the proxy graphical objects or the graphical objects, places the graphical objects in consistently spaced and sized cells of the container based on the spine path, and routes the connectors between the graphical objects based on the proxy diagram. In addition, the present disclosure provides techniques and systems to permit the user to edit the diagram by editing any of the types of input data. Further, the present disclosure provides techniques and systems to permit the user to edit the input data by editing or revising the diagram. The present disclosure provides techniques and systems to remove a burden of laying out the diagram from the user that results in consistently sized and arranged diagrams. Accordingly, the present disclosure provides techniques and systems that are improvements over other diagram systems when generating the diagram or generating the diagram based on multiple types of input data.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

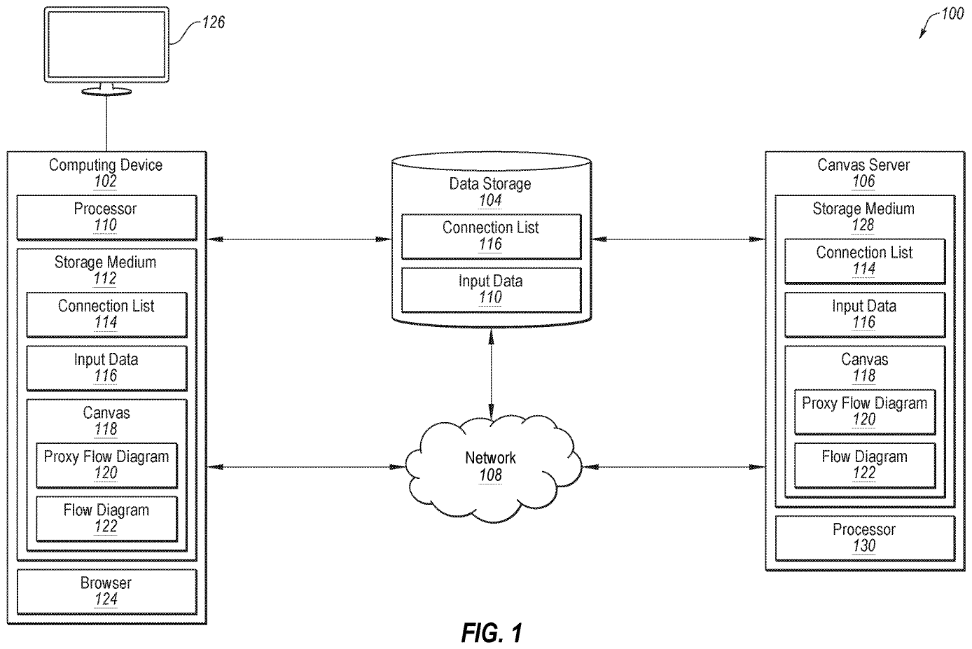

FIG. 1 illustrates a block diagram of an example operating environment 100 for a computing device 102 configured to generate a diagram 122 or a proxy diagram 120 within a canvas 118, arranged in accordance with at least one embodiment described herein. As shown in FIG. 1, the environment 100 includes the computing device 102, a network 108, a data storage 104, and a canvas server 106.

The computing device 102 may include a desktop computer, a laptop computer, a tablet computer, a mobile phone, a smartphone, a personal digital assistant (PDA), a wearable device (e.g., a smart watch), an interactive whiteboard (e.g., SURFACE HUB) or another suitable client device. The computing device 102 may include a processor 110, a storage medium 112, or both that host the canvas 118 to allow the computing device 102 to generate the proxy diagram 120 or the diagram 122. Additionally, the canvas 118 may allow the computing device 102 to reflect changes made to the input data 116, the proxy diagram 120, the diagram 122, or a combination thereof.

The canvas server 106 may be a computer system that provides services to the computing device 102 over the network 108. The canvas server 106 may include hardware components such as processor 130 and a storage medium 128. The processor 130 may be of any type such as a CPU, a μP, a μC, a DSP, or any combination thereof. The processor 130 may be configured to execute computer instructions that, when executed, cause the processor 130 to perform or control performance of one or more of the operations described herein with respect to the canvas server 106.

The processors 110 or 130 may be of any type such as a central processing unit (CPU), a microprocessor (μP), a microcontroller (μC), a digital signal processor (DSP), or any combination thereof. The processors 110 or 130 may be configured to execute computer instructions that, when executed, cause the processors 110 or 130 to perform or control performance of one or more of the operations described herein with respect to the computing device 102 or the canvas server 106.

The storage mediums 112 or 128 may include any non-transitory computer-readable medium, including volatile memory such as RAM, persistent or non-volatile storage such as ROM, EEPROM, CD-ROM or other optical disk storage, magnetic disk storage or other magnetic storage device, NAND flash memory or other solid state storage device, or other persistent or non-volatile computer storage medium. The storage mediums 112 or 128 may store computer instructions that may be executed by the processors 110 or 130 to perform or control performance of one or more of the operations described herein with respect to the computing device 102 or the canvas server 106.

The storage mediums 112 or 128 may additionally store the connection list 114, the input data 116, the proxy diagram 120, or the diagram 122. The connection list and/or the input data 116 may be generated for the proxy diagram 120 and/or the diagram 122 and/or may be imported from the canvas server 106, the data storage 104, or both. The connection list 114, the input data 116, the proxy diagram 120, or the diagram 122 may be imported over the network 108 or directly from the data storage 104, the computing device 102, or the canvas server 106 if a direct connection exists.

The computing device 102 may execute an application, such as a browser 124, configured to communicate through the network 108 with the canvas server 106, the data storage 104, or both. The browser 124 may include an Internet browser or other suitable application to communicate through the network 108. The browser 124 may generate, download and/or interact with the canvas 118, a connection list 114, input data 116, or any other appropriate information. In some embodiments, the computing device 102 may display the browser 124 including the canvas 118, the proxy diagram 120, or the diagram 122 via a display 126.

Embodiments described herein are not limited to using the browser 124 to communicate with the canvas server 106 or the data storage 104 to generate the proxy diagram 120 or the diagram 122. For example, rather than or in addition to the browser 124, the computing device 102 may include a native app as are often used on computing devices such as mobile devices including smartphones, tablet computers, and interactive whiteboards. Accordingly, embodiments described herein generally include generating the proxy diagram 120, the diagram 122, or both using a browser, a native app, or another suitable application on the computing device 102.

In general, the network 108 may include one or more wide area networks (WANs) and/or local area networks (LANs) that enable the canvas server 106, the computing device 102, or the data storage 104 to communicate with each other. In some embodiments, the network 108 may include the Internet, including a global internetwork formed by logical and physical connections between multiple WANs and/or LANs. Alternately or additionally, the network 108 may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network 108 may also include servers that enable one type of network to interface with another type of network.

The data storage 104 may include any memory or data storage. The data storage 104 may include network communication capabilities such that other components in the environment 100 may communicate with the data storage 104. In some embodiments, the data storage 104 may include computer-readable storage media for carrying or having computer-executable instructions or data structures stored thereon. The computer-readable storage media may include any available media that may be accessed by a general-purpose or special-purpose computer, such as a processor. For example, the data storage 104 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 104.

Although one computing device 102, one canvas server 106, and one data storage 104 are illustrated in FIG. 1, the environment 100 may more generally include one or more canvas servers 106, one or more computing devices 102, or one or more data storages 104. In these and other embodiments, the environment 100 may include other servers and/or devices not illustrated in FIG. 1.

With continued reference to FIG. 1, in some embodiments, the canvas server 106 and/or the computing device 102 may allow users to generate the connection list 114, the proxy diagram 120, or the diagram 122 within the canvas 118 based on the connection list 114 or the input data 116 via the processor 130 of the canvas server 106, the processor 110 of the computing device 102, or both. The diagram 122 may include graphical objects representative of information in the input data 116. As an example, the canvas 118 may include a virtual whiteboard application such as LUCIDSPARK, MURAL, MIRO, CONCEPTBOARD, ZITEBOARD, MICROSOFT WHITEBOARD, or other virtual whiteboard application.

The canvas 118 as used herein may refer to a document or other file that includes graphical objects generated, formatted, and/or grouped by users on a graphical drawing canvas. Alternatively or additionally, the canvas 118 may include data collections and/or pointers to data collections used to generate, format, or group graphical objects.

Aspects described as being performed by the processor 110 of the computing device 102 may be performed by the processor 130 of the canvas server 106 and vice versa. For ease of discussion, the following discussion describes the processor 110 of the computing device 102 as performing the various aspects. However, these aspects may be performed by the processor 130 of the canvas server 106 in addition to or instead of the processor 110.

In some embodiments, the processor 110 may generate a universal document (not shown) in a universal markup language. The universal markup language may include any language that uses characters, tags, or both to indicate structure or formatting of text-based information. In these and other embodiments, the universal document in the universal markup language may form a foundation of the proxy diagram 120 or the diagram 122. The processor 110 may convert the input data 116 including text, computer code, user input, or other types of input data to the universal markup language. For example, the input data 116 may include text generated by a large language model and the processor 110 may convert that text to the universal markup language. As another example, the input data 116 may include API calls and the processor 110 may gather information from corresponding sources based on the API calls. The processor 110 may convert the gathered information to the universal markup language.

The universal markup language may include any language that uses characters, tags, or both to indicate structure or formatting of text-based information. However, the universal markup language may not indicate location of the text-based information (e.g., locations for corresponding graphical objects in the diagram 122). Accordingly, the processor 110 may determine the location of the graphical objects in the diagram 122.

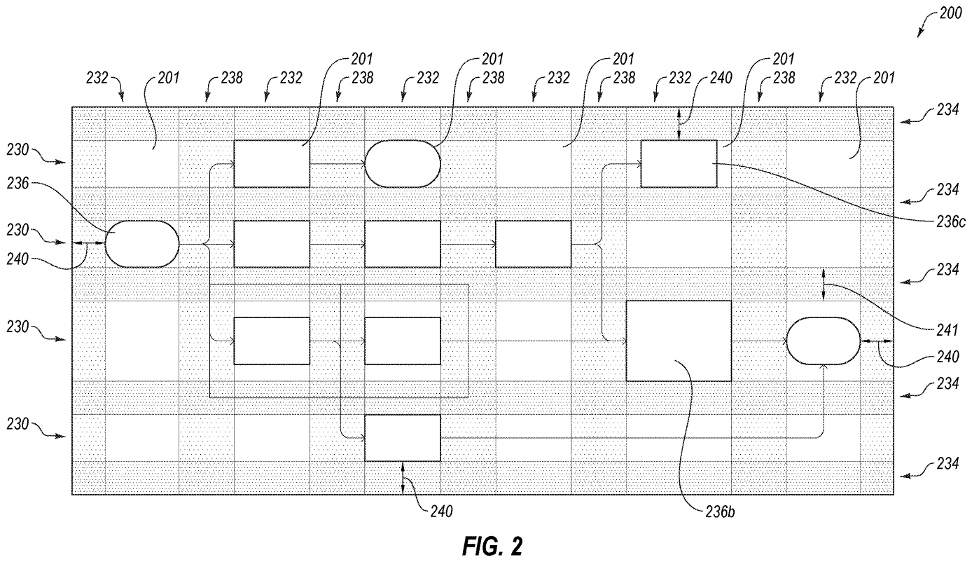

FIG. 2 illustrates an example container 200 that may be implemented in the canvas 118, arranged in accordance with at least one embodiment described herein. With reference to FIGS. 1 and 2, the container 200 may correspond to a portion of the canvas 118 such that a corresponding formatting applies only to an area within the container 200.

In some embodiments, the container 200 may be generated based on user input received via a user interface (UI) displayed via the display 126. For example, the UI may include a button, a menu, a field, or any other appropriate interface for the user to click, touch, or otherwise engage with to generate the container 200. In some embodiments, boundaries of the container 200 may be visible. Alternatively, the boundaries of the container 200 may be invisible. In some embodiments, the processor 110 may cause the boundaries of the container 200 to toggle between being visible and invisible based on user input.

The container 200 may include a cell formatting for positioning graphical objects 236a-c (generally referred to herein as graphical objects 236) within the container 200. Three instances of the graphical objects 236 are numbered 236a-c in FIG. 2 for ease of illustration. In some embodiments, the container 200 may include a rectangular grid comprising rows 230 and columns 232 that form cells 201. The cells 201 may indicate spacing for the graphical objects 236 within the container 200. A single row 230 of the cells 201 is numbered in FIG. 2 for ease of illustration.

As discussed in more detail below, the container 200 may initially include a single cell 201 formed by a single row 230 and a single column 232. Additionally, as discussed in more detail below, as graphical objects 236 are added to or removed from the container 200, the number of rows 230 and/or the number of columns 232 may change. In some embodiments, an initial size of the cells 201 may be equal to a default size of the graphical objects 236 or a numeric multiple of the default size of the graphical objects.

The container 200 may also include buffer rows 234 and/or buffer columns 238 to maintain a particular distance (indicated by arrows 241) between the cells 201. The buffer rows 234 and/or the buffer columns 238 may maintain the particular distance 241 between the cells 201. Additionally or alternatively, the buffer rows 234 and/or the buffer columns 238 may maintain a particular distance (indicated by arrows 240) between the cells 201 and a boundary of the container 200. In some embodiments, the particular distance 241 between the cells 201 may be different than the particular distance 240 between the cells 201 and the boundary of the container 200. The particular distance 241 may cause uniform spacing to occur between instances of the graphical objects 236. Additionally or alternatively, the particular distance 240 may cause uniform spacing to occur between the graphical objects 236 and the boundary of the container 200.

In some embodiments, the processor 110 may receive input effective to adjust a dimension of the particular distances 240 or 241. For example, the input may be effective to reduce or increase a length of the particular distances 240 or 241. The processor 110 may adjust the locations of the cells 201 within the container 200 to maintain the adjusted dimension of the particular distance 241. Additionally, the processor 110 may adjust dimensions of the container 200 to maintain the particular distance 240.

In some embodiments, the canvas 118 may include multiple containers with multiple formats to generate different types of diagrams within the canvas 118. For example, one container may include a frame format to generate a frame diagram, another container may include a swim lane format to generate a swim lane diagram, and another container may include an ERD format to generate an ERD diagram. Accordingly, the containers may generate multiple diagrams of different formats within the canvas 118. Additionally or alternatively, a single container may include nested formats to create multiple types of diagrams within a single container within the canvas 118.

The processor 110 may associate the graphical objects 236 with different cells 201 within the container 200. The graphical objects 236 may include any appropriate shape or size, which may be based on a corresponding shape library. When the graphical objects 236 are associated with the different cells 201, the graphical objects 236 may be constrained to the corresponding cells (e.g., corresponding rows 230 and columns 232).

The processor 110 may set a size of the cells 201 based on the size of the graphical objects 236. The processor 110 may identify various dimensions of the graphical objects 236 in the rows 230 and in the columns 232. In addition, the processor 110 may identify the largest graphical object 236 in each of the rows 230 and each of the columns 232. For example, the processor 110 may identify the graphical object 236b as the largest graphical object in the corresponding row 230 and the corresponding column 232.

The processor 110 may set particular dimensions of the cells 201 of each of the rows 230 and of each of the columns 232 based on the corresponding largest graphical object 236. For example, the processor 110 may set the height of the cells 201 in the row 230 corresponding to the graphical object 236b based on the height of the graphical object 236b. As another example, the processor 110 may set the width of the cells 201 in the column 232 corresponding to the graphical object 236b based on the width of the graphical object 236b.

The size of the container 200 may be based on the numbers of the rows 230, the columns 232, or both within the container 200. Additionally or alternatively, the size of the container 200 may be based on the sizes of the rows 230, the columns 232, or both within the container 200. In other words, the size of the container 200 may be based on the sizes of the cells 201 within the container 200. In some embodiments, the size of the container 200 may be manually adjusted or set. For example, a corner of the container 200 may be grabbed and dragged to increase or decrease the size of the container 200.

The processor 110 may position the graphical objects 236 within the corresponding cells 201 such that center points of the graphical objects 236 and center points of the cells 201 at least partially overlap. In other words, the processor 110 may position the graphical objects 236 within the cells 201 such that the graphical objects 236 are centered. For example, as shown in FIG. 2, the graphical object 236a is centered in the corresponding cell 201 such that distances exist between the graphical object 236a and the corresponding buffer rows 234. As another example, as shown in FIG. 2, the graphical object 236c is centered in the third cell 201c such that distances exist between the graphical object 236c and the corresponding buffer columns 238.

The processor 110 may position graphical objects 236 within the corresponding cells 201 at locations other than the center points of the cells 201 and relative to the center points of the graphical objects 236. For example, the processor 110 may position the graphical objects 236 relative to a boundary, an edge, a corner, or another location within the cells 201. The position of the graphical objects 236 within the cells 201 may be determined based on an alignment parameter, a margin parameter, an offset value, or user input. The graphical objects 236 may remain constrained to the locations of the cells as the cells 201, the rows 230, or the columns 232 are resized.

In some embodiments, the processor 110 may place the graphical objects 236 such that they are associated with multiple rows 230, multiple columns 232, or both. The graphical objects 236 may span multiple cells 201 within the container 200 (referred to herein as “cell spanning”). When the graphical objects 236 span the multiple cells 201, the graphical objects 236 may be positioned relative to the multiple cells 201 as a unified region. The multiple cells 201 may automatically resize in response to changes in sizes of the rows 230 and/or the columns 232 spanned by the graphical objects 236. In such embodiments, the graphical objects 236 that span multiple cells 201 may not affect sizes of the rows 230 or the columns 232 that are spanned over by the graphical objects 236. For example, a graphical object that spans from a first row to a third row may not affect the size of a second row because the graphical object spans over the second row. Alternatively, the graphical objects 236 that span multiple cells 201 may affect sizes of the rows 230 or the columns 232 that are spanned over by the graphical objects 236. For example, the graphical object that spans from the first row to the third row may affect the size of the second row despite spanning over the second row. Further, connectors may be routed to or from the graphical objects 236 spanning the multiple cells 201 in a same or similar manner as connectors routed to graphical objects 236 associated with a single cell. In some embodiments, the graphical objects 236 that span multiple cells 201 may be centered over the rows 230 or the columns 232 that they span. In these and other embodiments, the graphical objects 236 that span multiple cells 201 may not automatically resize to fit the dimensions of the rows 230 or the columns 232.

In some embodiments, the processor 110 may position the graphical object 236 using a precision placement mode that permits the graphical objects 236 to be anchored to a relative position of another graphical object 236 or to a relative position of a cell 201 within the container 200. The relative position may correspond to a predefined anchor location, such as a corner, an edge midpoint, or a center point of a target graphical object 236 or cell 201. When positioned using the precision placement mode, the graphical objects 236 may maintain the relative position as the target graphical object 236 or the cell 201 is moved or resized. In some embodiments, multiple graphical objects 236 may be precision placed relative to a same target graphical object 236 or cell 201. The graphical objects 236 positioned using the precision placement mode may not serve as a target for precision placement of other graphical objects 236. Further, connectors attached to the graphical objects 236 positioned using the precision placement mode may not be automatically routed.

In some embodiments, the processor 110 may place the container 200 such that is nested within another container (not shown) that also applies cell formatting. For example, the container 200 may be placed within the boundaries of the another container. The container 200 (e.g., the nested container) may define and apply its own cell formatting to the graphical objects 236, independently of the cell formatting applied by the another container. In such embodiments, the container 200 may include grid properties that differ from the grid properties of the another container. For example, the container may include different spacing of the rows 201 or the columns 232, a different number of the rows 201 or the columns 232, or different sizes of the rows 230 or the columns 232. In some embodiments, the container 200, when nested in the another container, may inherit one or more grid properties from the another container. For example, the container 200, when nested in the another container, may inherit the sizes of the rows 230 from the another container. Further, the container 200 may be positioned within one or more cells of the another container and may span multiple rows, columns, or both of the another container.

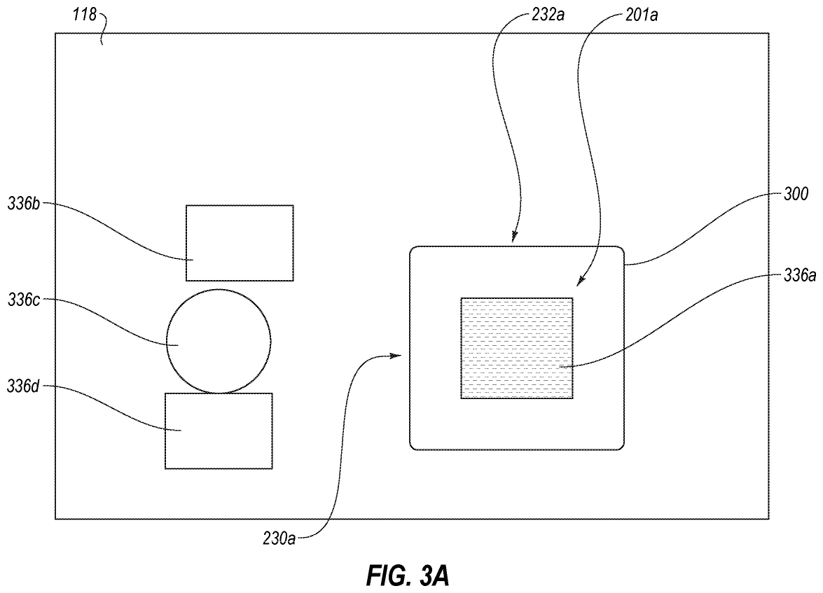

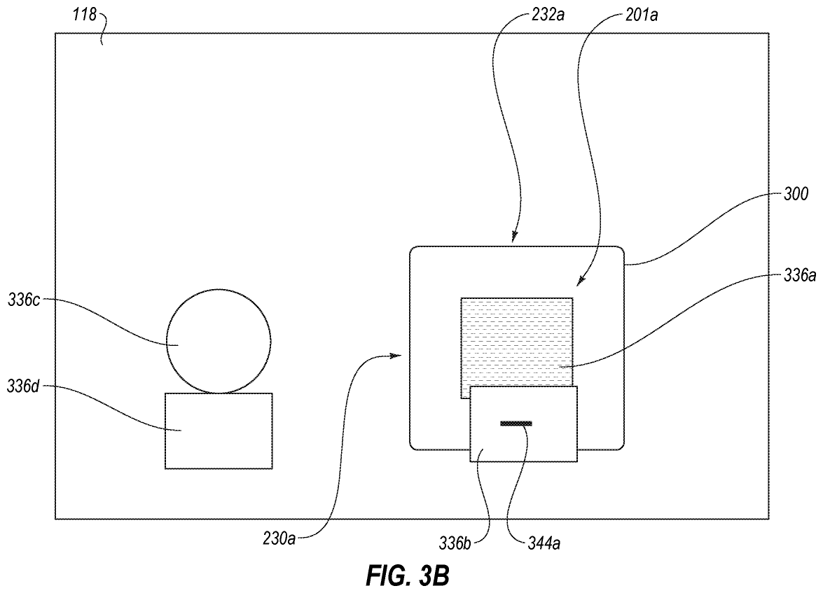

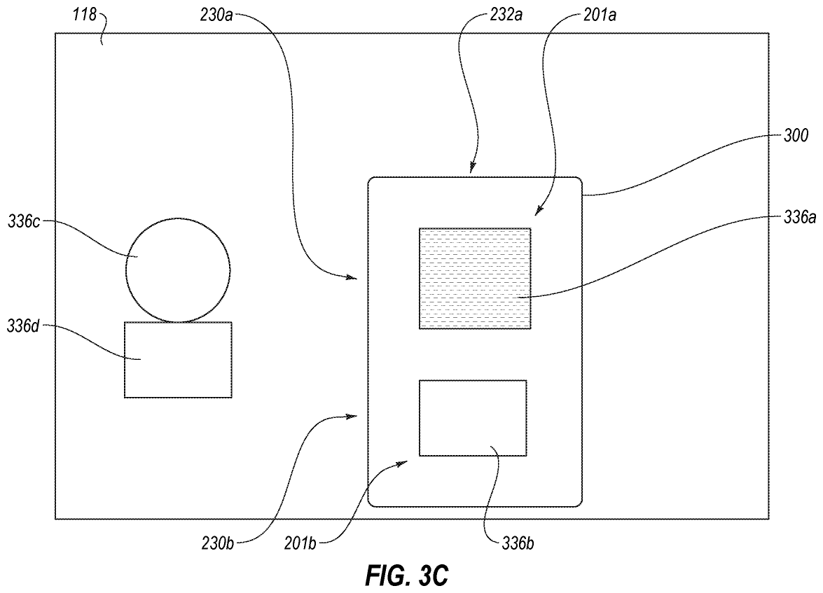

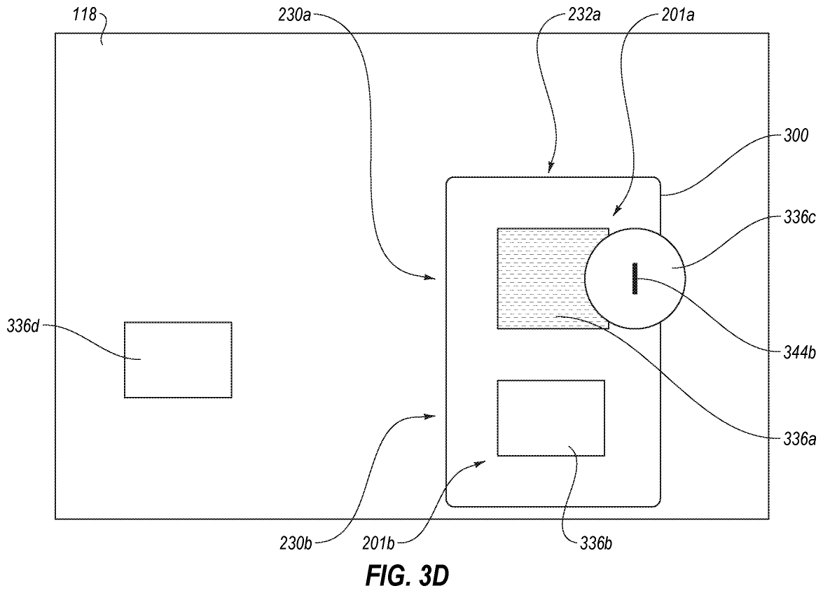

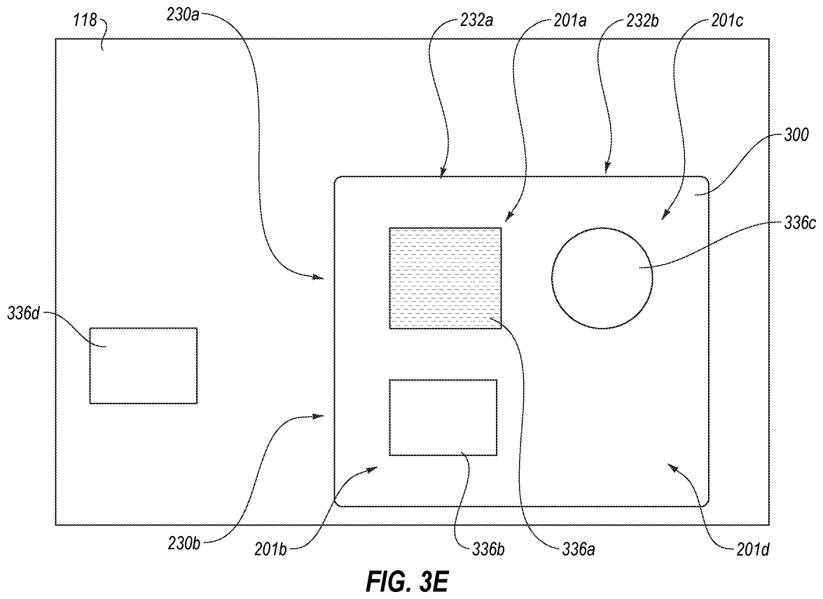

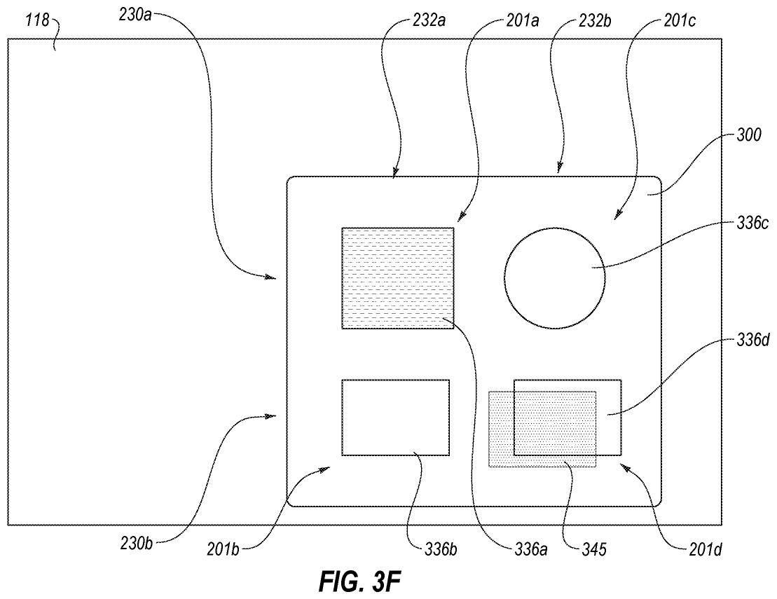

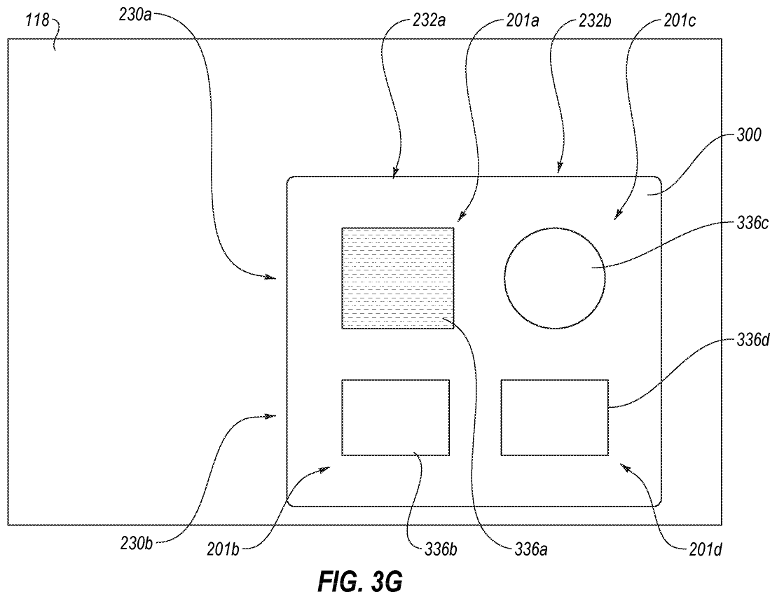

FIGS. 3A-3G illustrate an example of the canvas 118 of FIG. 1 including graphical objects 336a-d and an example container 300, arranged in accordance with at least one embodiment described herein. With combined reference to FIGS. 1 and 3A-3G, the graphical objects 336a-b may be positioned in the container 300 to create cells 201a-d, rows 230a-b, and columns 232a-b within the container 300. In other words, as the graphical objects 236a-d are moved within the canvas 118 (e.g., into the container 300), the rows 230, the columns 232, or the cells 201 may increase or decrease or otherwise change. The buffer rows 234 and the buffer columns 238 of the container 300 are not illustrated in FIGS. 3A-3G. The following description discusses the graphical objects 336b-d being positioned within the container 300 based on user input. However, the graphical objects 336a-d may be positioned within the container 300 based on the input data 116 indicating that the proxy diagram 120 includes the graphical objects 336a-d. Accordingly, the processor 110 may perform various steps described below without receiving user input.

As shown in FIG. 3A, the container 300 initially includes the graphical object 336a positioned within a first cell 201a created by a first row 230a and a first column 232a. A size of the first cell 201a (e.g., a height of the first row 230a and a width of the first column 232a) may be based on the height and the width of the graphical object 336a.

As shown in FIG. 3B, the processor 110 may receive input effective to position (e.g., place) the graphical object 336b within the container 300. For example, the input may cause the graphical object 336b to hover over a particular location in the container 300. The processor 110 may display a drop zone indicator 344a (referred to herein as row indicator 344a) based on the graphical object 336b hovering over the particular location. The row indicator 344a includes a particular indicium indicating that placement of the graphical object 336b at the particular location will cause a new row to be created within the container 300.

As shown in FIG. 3C, the processor 110 may generate a second cell 201b within the container 300 based on the input. Additionally, the processor 110 may generate the second row 230b within the container 300. The processor 110 may position the graphical object 336b within the second cell 201b such that a center point of the graphical object 336b and a center point of the second cell 201b at least partially overlap. In addition, the processor 110 may position the graphical object 336b within the second cell 201b such that the graphical objects 336a-b form the first row 230a.

The second cell 201b may include a size based on the size of one or more of the graphical objects 336a-b. For example, the width of the second cell 201b is equal to a width of both of the graphical objects 336a-b. As another example, the height of the second cell 201b is equal to the height of the graphical object 336b. Additionally or alternatively, the rows 230a-b or the first column 232a may include sizes based on the sizes of one or more of the graphical objects 336a-b.

The processor 110, based on the generation of the second cell 201b, may adjust a location of the first cell 201a within the container 300. For example, as shown in FIG. 3C, the processor 110 may adjust the location of the first cell 201a from a center point of the container 300 to an upper portion of the container 300. The processor 110 may adjust the location of the first cell 201a to maintain the particular distance between the first cell 201a (e.g., a boundary of the first cell 201a) and the boundary of the container 300. Additionally, the processor may set the location of the second cell 201b to maintain the particular distance between the second cell 201b and the boundary of the container 300.

As shown in FIG. 3D, the processor 110 may receive input effective to position (e.g., place) the graphical object 336c within the container 300. For example, the input may cause the graphical object 336c to hover over a particular location in the container 300. The processor 110 may display a drop zone indicator 344b (referred to herein as column indicator 344b) based on the graphical object 336c hovering over the particular location. The column indicator 344b includes a particular indicium indicating that placement of the graphical object 336c at the particular location will cause a new column to be created within the container 300.

As shown in FIG. 3E, the processor 110 may generate a third cell 201c and a fourth cell 201d (e.g., the second column 232b) within the container 300 based on the input. The processor 110 may position the graphical object 336c within the third cell 201c such that a center point of the graphical object 336c and a center point of the third cell 201c at least partially overlap. In addition, the processor 110 may position the graphical object 336c within the third cell 201c such that the graphical objects 336a and c are within the first row 230a.

The third cell 201c may include a size based on the size of one or more of the graphical objects 336a and c. For example, the width of the third cell 201c is equal to a width of the graphical object 336c. As another example, the height of the third cell 201c is equal to a height of both of the graphical objects 336a and c. Additionally or alternatively, the rows 230a-b or the columns 232a-b may include sizes based on the sizes of one or more of the graphical objects 336a-c.

The processor 110, based on the generation of the third cell 201c (e.g., the second column 232b), may adjust a location of the first cell 201a, the second cell 201b, or both within the container 300. For example, as shown in FIG. 3E, the processor 110 may move the location of the first cell 201a and the second cell 201b from a vertical center of the container 300 to a left portion of the container 300. The processor 110 may adjust the location of the first cell 201a and the second cell 201b to maintain the particular distance between the first cell 201a and the second cell 201b and the boundary of the container 300. Additionally, the processor may set the location of the third cell 201c and the fourth cell 201d to maintain the particular distance between the third cell 201c and the fourth cell 201d and the boundary of the container 300.

As shown in FIG. 3F, the processor 110 may receive input effective to position (e.g., place) the graphical object 336d within the container 300. For example, the input may cause the graphical object 336d to hover over a particular location in the container 300 (e.g., a location corresponding to the fourth cell 201d). The processor 110 may display a drop zone indicator 345 (referred to herein as cell indicator 345) based on the graphical object 336d hovering over the particular location. The cell indicator 345 includes a particular indicium indicating that placement of the graphical object 336d at the particular location will cause the graphical object 336d to be positioned within the fourth cell 201d (e.g., within a pre-existing cell).

As shown in FIG. 3F, the processor 110 may position the graphical object 336d within the fourth cell 201d such that a center point of the graphical object 336d and a center point of the fourth cell 201d at least partially overlap. In addition, the processor 110 may position the graphical object 336d within the fourth cell 201d such that the graphical objects 336c-d form the second column 232b. Further, the processor 110 may position the graphical object 336d within the fourth cell 201d such that the graphical objects 336b and d form the second row 230b.

The fourth cell 201d may include a size based on the size of one or more of the graphical objects 336b-d. For example, the width of the fourth cell 201d is equal to a width of both of the graphical objects 336c-d. As another example, the height of the fourth cell 201d is equal to the height of both of the graphical objects 336b and d. Additionally or alternatively, the rows 230a-b or the first column 232a may include sizes based on the sizes of the graphical objects 336a-d.

The processor 110 may set a size of the container 300 based on the size of the cells 201a-d, the rows 230a-b, the columns 232a-b, or some combination thereof. For example, as shown in FIGS. 3A-3G, the processor 110 may increase the height and the width of the container 300 as additional cells 201b-d, the second row 230b, or the second column 232b are generated. The processor 110 may adjust the size of the container 300 to maintain the particular distance between the boundary of the container 300 and boundaries of the cells 201a-d.

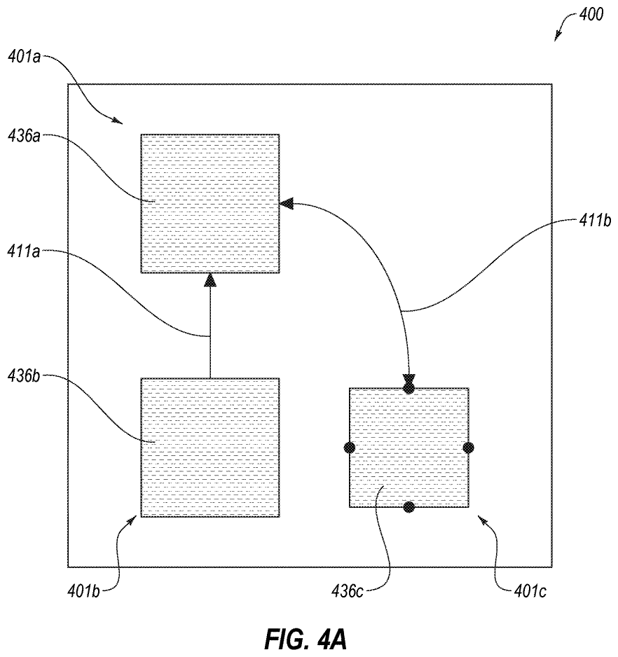

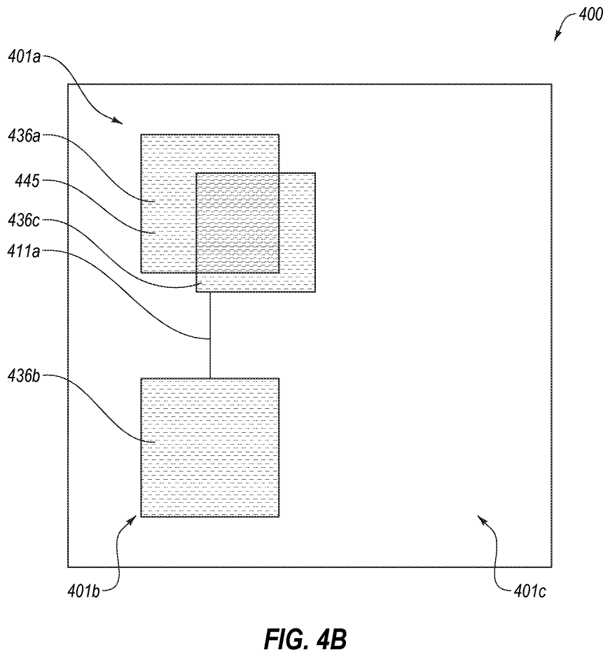

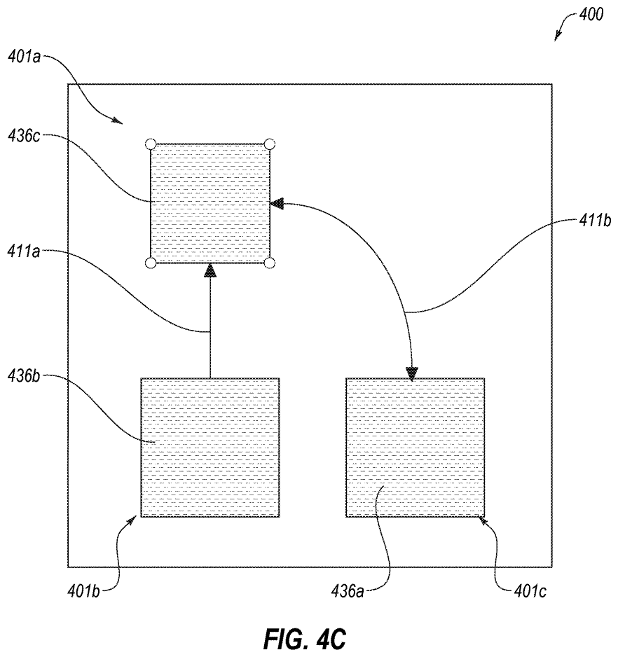

FIGS. 4A-4C illustrate an example container 400 including graphical objects 436a-c that may be implemented in the canvas 118 of FIG. 1, arranged in accordance with at least one embodiment described herein. With combined reference to FIGS. 1 and 4A-4C, the graphical objects 436a-b may be positioned within cells 401a-c within the container 400. As shown in FIG. 4A, graphical objects 436a-c may be positioned within the cells 401a-c in an initial arrangement.

As shown in FIG. 4B, the processor 110 may receive input effective to move the graphical object 436c within the container 400. The input may be effective to position the graphical object 436c within the first cell 401a. For example, the input may cause the graphical object 436c to hover over at least a portion of the first cell 401a, the graphical object 436a, or both. The processor 110 may display a drop zone indicator 445 (referred to herein as cell indicator 445) based on the graphical object 436c hovering over the portion of the first cell 401a. The cell indicator 445 includes a particular indicium indicating that placement of the graphical object 436c in the first cell 401a will cause the graphical object 436c to be positioned within the first cell 401a. In addition, the cell indicator 445 may indicate that placement of the graphical object 436c in the first cell 401a will cause the graphical object 436a to move to another cell (e.g., the third cell 401c).

As shown in FIG. 4C, the processor 110 may automatically swap the location of the graphical objects 436a and 436c within the container 400. The processor 110, based on the input, may move the graphical object 436a to the third cell 401c and may move the graphical object 436c to the first cell 401a. The processor 110 may cause connectors 411a-b to maintain association with initial corresponding cells 401a-c despite the graphical objects 436a and 436c swapping locations within the container 400. For example, as shown in FIG. 4C, the connector 411a now extends from the graphical object 436b to the graphical object 436c and the connector 411b now extends between the graphical object 436a and the graphical object 436c.

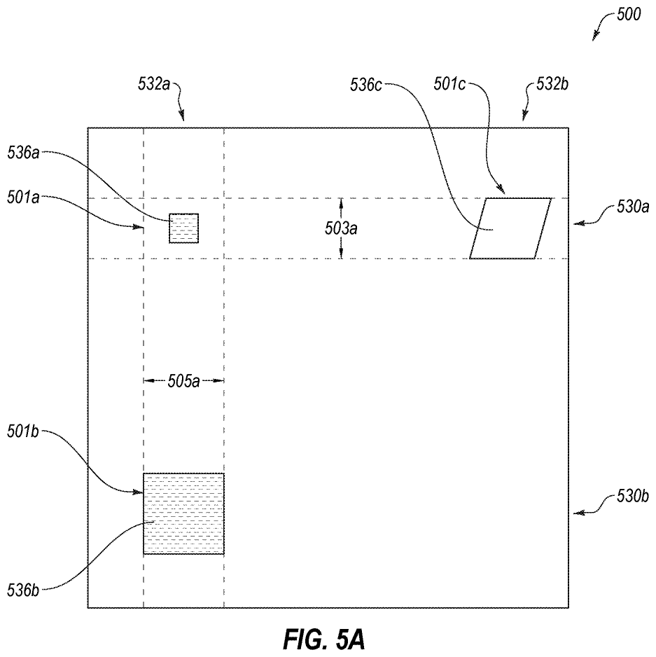

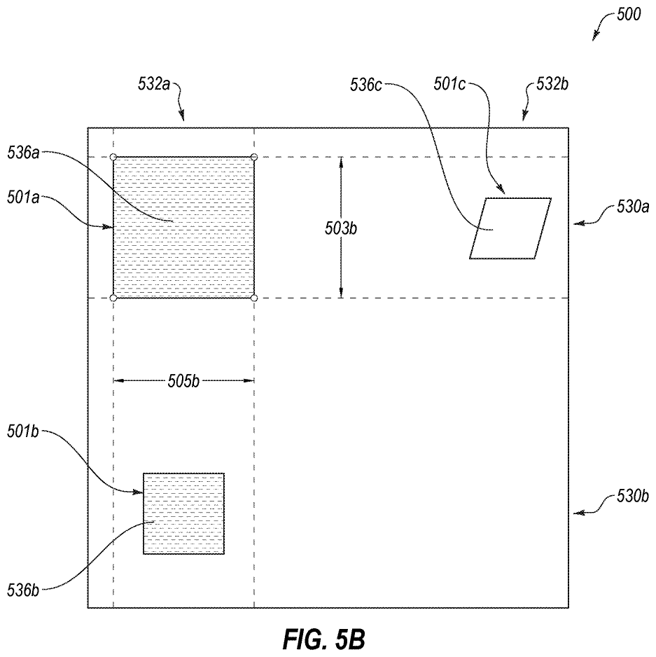

FIGS. 5A and 5B illustrate an example container 500 that may be implemented in the canvas 118 of FIG. 1, arranged in accordance with at least one embodiment described herein. With combined reference to FIGS. 1, 5A, and 5B, the graphical objects 536a-c may be positioned within cells 501a-c of the container 500. The cells 501a-c may form rows 530a-b and columns 532a-b within the container 500.

As shown in FIG. 5A, an initial height (indicated by arrow 503a) of the row 530a is based on a height of the graphical object 536c. In addition, as shown in FIG. 5A, an initial width (indicated by arrow 505a) of the column 532a is based on a width of the graphical object 536b. The processor 110 may receive input effective to adjust the size of the graphical object 536a. For example, the input may include a drag action to adjust a boundary of the graphical object 536a. As another example, the input may include typed text input indicating new dimensions of the graphical object 536a.

The input may cause the processor 110 to adjust the size of the graphical object 536a such that at least one dimension of the graphical object 536a is greater than a corresponding dimension of the graphical objects 536b-c. As shown in FIG. 5B, the height of the graphical object 536a became greater than the height of the graphical object 536c. In addition, as shown in FIG. 5B, the width of the graphical object 536a became greater than the width of the graphical object 536b.

As shown in FIG. 5B, the processor 110 may adjust the height of the row 530a (indicated by arrow 503b) (e.g., the cells 501a and 501c) to be based on a height of the graphical object 536a rather than the height of the graphical object 536c. In addition, as shown in FIG. 5B, the processor 110 may adjust the width (indicated by arrow 505b) of the column 532a to be based on a width of the graphical object 536a rather than the width of the graphical object 536b. In addition, the processor 110 may adjust a size of the container 500 based on the adjusted sizes of the cells 501a-c. The processor 110 may adjust the size of the container 500 to maintain a particular distance between boundaries of the cells 501a-c and a boundary of the container 500.

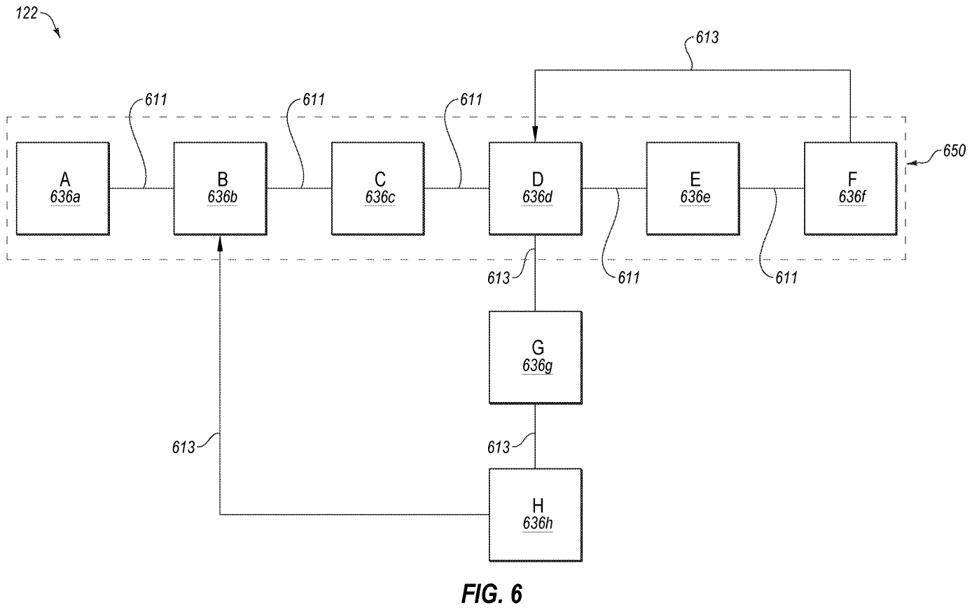

FIG. 6 illustrates an example of the diagram 122 of FIG. 1, arranged in accordance with at least one embodiment described herein. The diagram 122 shown in FIG. 6 includes graphical objects 636a-f arranged in a spine path 650 and additional graphical objects 636g-h. With combined reference to FIGS. 1 and 6, the processor 110 may generate the connection list 114 based on the input data 116. Alternatively, the processor 110 may receive the connection list 114 from the canvas server 106 or the data storage 104.

The connection list 114 may identify the graphical objects 636a-h that are to be included in the diagram 122. In addition, the connection list 114 may indicate connections (e.g., edges) between the graphical objects 636a-h. In some embodiments, the connection list 114 may indicate connectors are already present between two or more of the graphical objects 636-h and that these connectors are not to be changed.

The processor 110 may identify two or more of the graphical objects 636a-h as a start point and an end point of the diagram 122 based on the connection list 114. In some embodiments, the processor 110 may identify the two or more graphical objects 636a-h as the start point and the end point to represent a beginning and an end of a process corresponding to the diagram 122. In other embodiments, the processor 110 may process the input data 116 to identify the two or more graphical objects 636a-h as the start point and the end point. In some embodiments, the input data 116, the connection list 114, or both may identify the graphical objects 636a-h that correspond to the start point and the end point for the diagram 122.

The processor 110 may identify the spine path 650 based on the connection list 114. The spine path 650 may include a path of the graphical objects 636a-h that includes a fewest number of existing connectors, a shortest path from the start point to the end point, a fewest number of the graphical objects 636a-h, a path that includes a particular graphical object, or any other appropriate parameter. For example, the spine path 650 shown in FIG. 6 is the shortest path between the graphical objects 636a and 636f.

In some embodiments, the processor 110 may generate multiple potential spine paths from the start point to the end point based on the connection list 114. Each of the potential spine paths may represent a potential sequence of the graphical objects 636a-h from the start point to the end point. Each of the potential spine paths may include a number of the graphical objects 636a-h. For example, each of the potential spine paths may include the graphical objects 636a and 636f as the start point and the end point respectively and some or none of the graphical objects 636b-e as intermediary graphical objects. The processor 110 may compare the number of existing connectors, the number of the graphical objects 636a-h in the different potential spine paths, a path that includes a particular graphical object, or any other appropriate parameter of each of the potential spine paths. The processor 110 may identify one of the potential spine paths as the spine path 650 due to it including the fewest number of existing connectors, the fewest number of graphical objects, or a path that includes a particular graphical object.

The processor 110 may identify the graphical objects 636g-h that are not included in the spine path 650, connections (e.g., edges) (referred to in the present disclosure as omitted connections) that are not included in the spine path 650, or both based on the connection list 114. An example omitted connection includes the connection from the graphical object 636f to the graphical object 636d. Additionally, the processor 110 may identify additional paths from these graphical objects 636g-h to the graphical object 636f (e.g., the end point) based on the connection list 114. Further, the processor 110 may identify additional paths for the omitted connections based on the connection list 114.

The additional paths may be identified in a same or similar manner as the spine path 650 described above but in relation to the graphical objects 636g-h or the omitted connections rather than the graphical objects 636a-f. The processor 110 may iteratively identify additional paths from the graphical objects 636g-h to the spine path 650 based on the connection list 114. For example, the processor 110 may identify the additional path for the graphical object 636g during a first iteration and for the graphical object 636h during a second iteration.

The processor 110 may route connectors 611 between the graphical object 636a (e.g., the start point) and the graphical object 636f (e.g., the end point) to connect the graphical objects 636a-f along the spine path 650. The connectors 611 may indicate a flow of the spine path 650. Additionally, the processor 110 may route connectors 613 between the graphical objects 636g-h or for the omitted connections and the spine path 650 to connect the graphical objects 636g-h or the omitted connections to the spine path 650.

The processor 110 may identify the spine path 650 or the additional paths using a forward algorithm, a backward algorithm, or a tree algorithm. The forward algorithm may start at the start point (e.g., the graphical object 636a for the spine path 650 or any of the graphical objects 636f-h for the additional paths) and route the connectors 611 or 613 to the end point (e.g., the graphical object 636f). The backward algorithm may start at the end point (e.g., the graphical object 636f for the spine path 650 and the additional paths) and route the connectors 611 or 613 to the start point (e.g., the graphical object 636a). The tree algorithm may generate a visualization of multiple paths in a hierarchical structure of nodes and edges. In some embodiments, the processor 110 may receive user input to toggle between the different algorithms.

The processor 110 may generate the diagram 122 with the graphical objects 636a-h and the connectors 611 and 613. The processor 110 may arrange the graphical objects 636a-h using a container that includes a cell formatting as described above. Additionally, the processor 110 may route the connectors 611 and 613 using auto layout features as described in more detail below.

An example of the connection list 114 the processor 110 may use to generate the diagram 122 shown in FIG. 6 includes: {‘Nodes’: [‘A’, ‘B’, ‘C’, ‘D’, ‘E’, ‘F’, 'G', 'H'], 'Edges': [['A', ‘B’], [‘B’, ‘C’], [‘C’, ‘D’], [‘D’, ‘E’], [‘E’, ‘F’], ['F', 'D'], ['F', 'D'], ['D', 'G'], ['G', 'H'], ['H', 'B']], ‘Start’: ‘A’, ‘Ends’: [‘F’],}. In the example connection list, Node “A” corresponds to the graphical object 636a, Node “B” corresponds to the graphical object 636b, Node “C” corresponds to the graphical object 636c, Node “D” corresponds to the graphical object 636d, Node “E” corresponds to the graphical object 636e, Node “F” corresponds to the graphical object 636f, Node “G” corresponds to the graphical object 636g, and Node “H” corresponds to the graphical object 636h. The processor 110 may identify the graphical object 636a as the start point based on the text “‘Start’: ‘A”. In addition, the processor 110 may identify the graphical object 636f as the end point based on the text “‘Ends’: [‘F’]”.

In the example connection list 114, the processor 110 may process the text “‘Edges’: [[‘A’, ‘B’], [‘B’, ‘C’], [‘C’, ‘D’], [‘D’, ‘E’], [‘E’, 'F'], ['F', 'D'], ['F', 'D'], ['D', 'G'], ['G', 'H'], ['H', ‘B’]]” to identify possible paths from the graphical object 636a (e.g., the start point or Node “A”) to the graphical object 636f (e.g., the end point or Node “F”). As shown in FIG. 6, the processor may identify a possible path that starts at the graphical object 636a, traverses the graphical objects 636b-g, and ends at the graphical object 636f based on this example connection list 114. The processor 110 may identify the spine path 650 because there are no other paths between the graphical objects 636a and 636f indicated in the example connection list 114.

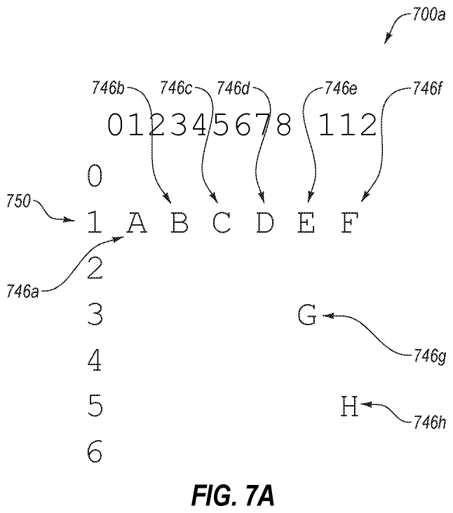

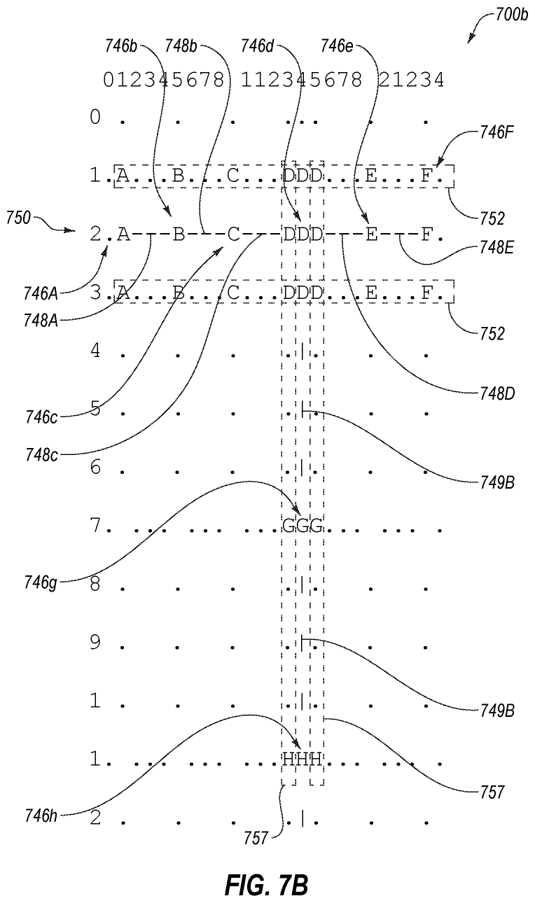

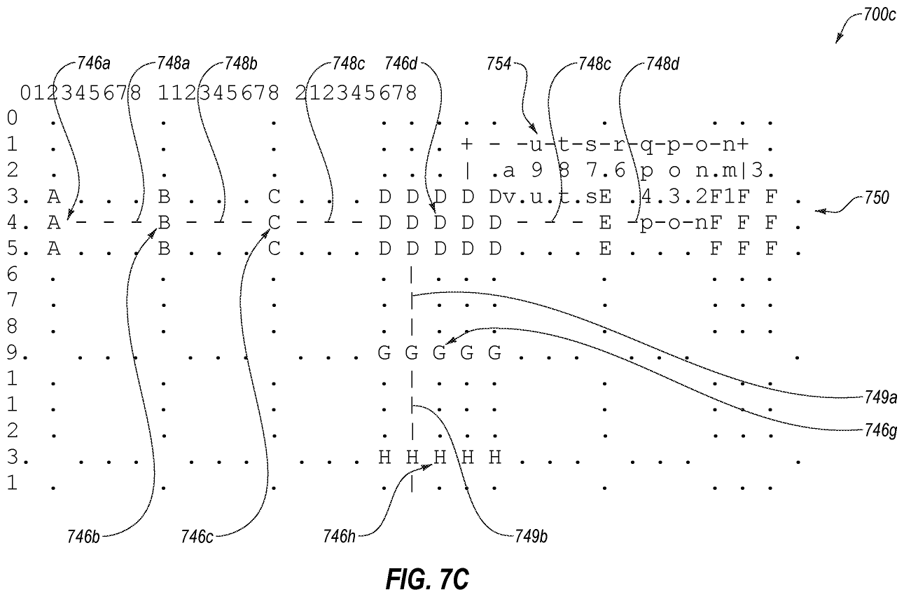

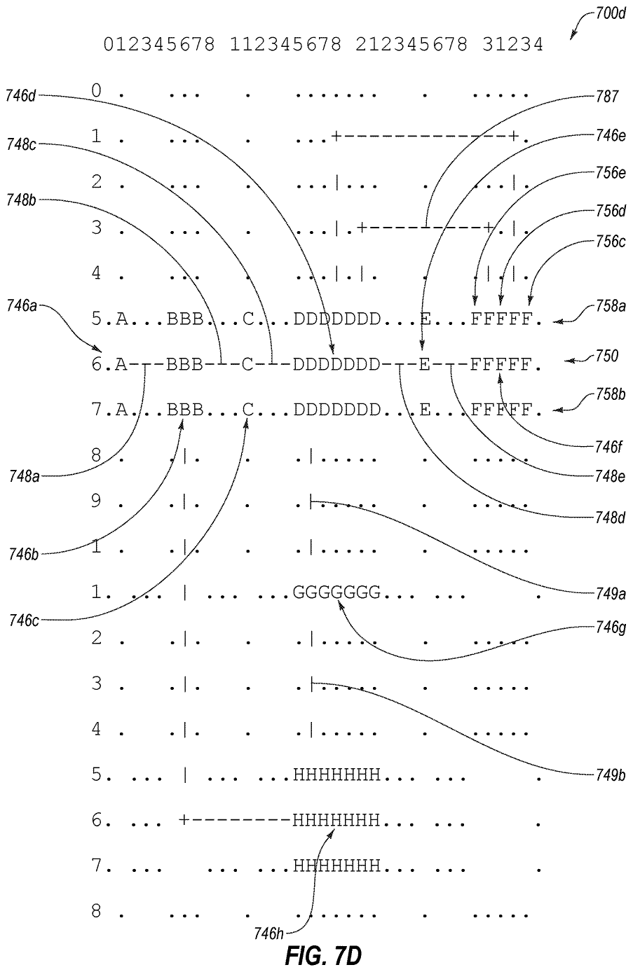

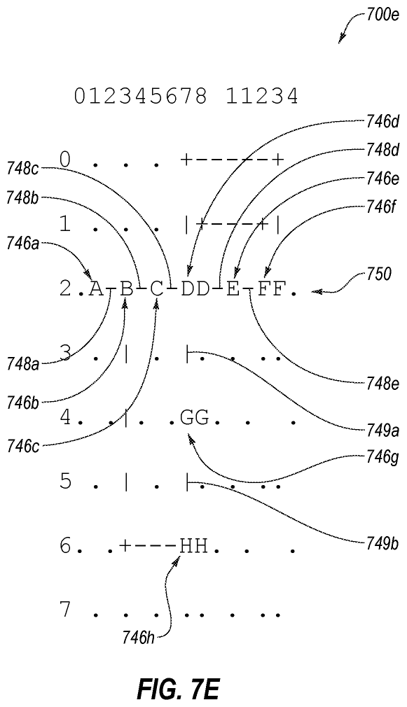

FIGS. 7A-7E illustrate example proxy diagrams 700a-e, arranged in accordance with at least one embodiment described herein. The example proxy diagrams 700a-e may correspond to the proxy diagram 120 of FIG. 1. With combined reference to FIGS. 1 and 7A-7E, the processor 110 may generate the example proxy diagrams 700a-e when updates are made to the input data 116 (e.g., manual manipulation of the diagram 122), when the input data 116 is received, or any other appropriate event. The proxy diagrams 700a-e correspond to the following example of the connection list 114: {‘Nodes’: [‘A’, ‘B’, ‘C’, ‘D’, ‘E’, ‘F’, ‘G’, ‘H’], ‘Edges’: [[‘A’, ‘B’], [‘B’, ‘C’], [‘C’, ‘D’], [‘D’, ‘E’], [‘E’, ‘F’], [‘F’, ‘D’], [‘F’, ‘D’], [‘D’, ‘G’], [‘G’, ‘H’], [‘H’, ‘B’]], ‘Start’: ‘A’, ‘Ends’: [‘F’],}.

The proxy diagrams 700a-e, including the proxy objects 746a-h (generally referred to in the present disclosure as proxy objects 746), may include a simplified representation of graphical objects. For example, graphical objects may include metadata and the proxy objects 746 may only include identifiers. In some embodiments, the proxy objects 746 may include representations of graphical objects as stored in the storage medium 112 (e.g., as stored in memory). Accordingly, the proxy diagrams 700a-e may include a representation of the diagram 122 as stored in the storage medium 112.

As shown in FIG. 7A, the processor 110 may generate the proxy diagram 700a including proxy objects 746 arranged in accordance with a grid. The processor 110 may arrange the proxy objects 746 in the grid based on the connection list 114. The processor 110 may identify a start point and an end point of the proxy diagrams 700a-e based on the connection list 114 in a same or similar manner as described in detail above but with respect the proxy objects 746 instead of graphical objects.

The proxy diagram 700a includes a spine path 750 that correlates to the spine path 650 described above. The processor 110 may identify the spine path 750 in a same or similar manner as discussed above in relation to the spine path 650. As shown in FIG. 7A, the spine path 750 includes the proxy objects 746a-f and is located in a row labelled “1”.

The processor 110 may identify the proxy objects 746g-h as not forming part of the spine path 750. In addition, the processor 110 may position the proxy objects 746g-h in separate rows in the proxy diagram 700a. For example, the proxy object 746g is located in a row labelled “3” in FIG. 7A and the proxy object 746h is located in a row labelled “5” in FIG. 7A. The proxy diagram 700a may include empty rows (labelled “0”, “2”, “4”, and “6” in FIG. 7A) between the spine path 750 and the graphical objects 746 to provide room for routing subsequent proxy connectors. Each instance of the proxy objects 746 may represent a port for routing a proxy connector into or out of the proxy objects 746 along the corresponding row or column. For example, each of the proxy objects 746 may be configured to connect to one proxy connector on the right and one proxy connector on the left along the corresponding rows. As another example, each of the proxy objects 746 may be configured to connect to one proxy connector on the top and one proxy connector on the bottom along the corresponding columns.

As shown in FIG. 7B, the processor 110 may route proxy connectors 748a-d between the proxy objects 746a-f of the spine path 750. The proxy objects 746a-f are connected to the proxy connectors 748a-d on a right side, a left side, or both along the corresponding row (e.g., the row labelled “2” in FIG. 7B). Accordingly, the processor may create duplicates 752 of the proxy objects 746a-f adjacent to the corresponding proxy objects 746a-f. In some embodiments, the processor 110 may create the duplicates 752 based on the connectors 748a-d being routed.

The duplicates 752, because the proxy connectors 748a-d are routed along the row, may form additional rows in the proxy diagram 700b to which subsequent proxy connectors may be connected. For example, the duplicates 752 create additional rows labelled “1” and “3” in FIG. 7B. In some embodiments, the duplicates 752 may operate to separate (e.g., split) the proxy diagram 700b along the graphical objects 746a-f of the spine path 750.

The processor 110 may determine the proxy object 746g is to be connected to the spine path 750. The processor 110 may identify additional paths from the proxy object 746g to the spine path 750. For example, the processor 110 may determine the proxy object 746g connects to the proxy object 746d without any intermediary proxy objects. The processor 110 may route a proxy connector 749a between the proxy object 746g and the proxy object 746d. In other words, the processor 110 may route the proxy connector 749a between the proxy object 746g and the spine path 750.

As shown in FIG. 7B, the proxy connector 749a is connected to a bottom side of the proxy object 746d and the proxy connector 749a is connected to a top side of the proxy object 746g along the corresponding column (e.g., the second column labelled “4” on the right in FIG. 7B). Accordingly, the processor 110 may create duplicates 757 of the proxy objects 746d and 746g adjacent to the corresponding proxy objects 746d and 746g. In some embodiments, the processor 110 may create the duplicates 757 based on the proxy connector 749a being routed.

The duplicates 757, because the proxy connector 749a is routed along the column, may form additional columns in the proxy diagram 700b along which subsequent proxy connectors may be connected. For example, the duplicates 757 create additional columns labelled “3” (e.g., the second column labelled “3” on the right) and “5” (e.g., the second column labelled “5” on the right) in FIG. 7B. In some embodiments, the duplicates 757 may operate to separate (e.g., split) the proxy diagram 700b along the proxy objects 746d and 746g.

The processor 110 may determine the proxy object 746h is to be connected to the spine path 750. The processor 110 may identify additional paths from the proxy object 746h to the spine path 750. For example, the processor 110 may determine the proxy object 746h connects to the proxy object 746d with the proxy object 746g as an intermediary proxy object. The processor 110 may route a proxy connector 749b between the proxy objects 746g and 746h. In other words, the processor 110 may route the proxy connector 749b to connect the proxy object 746h to the spine path 750 via the proxy object 746g.

As shown in FIG. 7B and previously discussed, the processor 110 may create duplicates 757 of the proxy objects 746d and 746g. Accordingly, as the proxy object 746h is added to the same column and is connected to the proxy connector 749b, the processor 110 may add copies of the proxy object 746h to the duplicates 757 (shown by the three instances of the letter H in FIG. 7B).

The processor 110 may determine the omitted connection between the proxy objects 746f and 746d is to be added to the proxy diagram. The processor 110 may generate multiple possible routes for the connection between the proxy object 746f and 746d. In some embodiments, these routes may be generated in accordance with a routing algorithm. Examples of the routing algorithm include A* search algorithm or any appropriate algorithm.

The processor 110 may route the proxy connector from the proxy object 746f to the proxy object 746g to minimize crossings of other proxy connectors, turns, bends, or other breaks in the proxy connector. For each possible route for the connection between the proxy object 746f and 746d, the processor 110 may determine a score based on the routing algorithm. As shown in FIG. 7C, the proxy diagram 700c includes various letters and numbers that may represent the score 754. The processor 110 may add up the score for each of the possible routes. In addition, the processor 110 may select the possible route corresponding to the lowest score as the additional path for omitted connection.

As shown in FIG. 7D, the processor 110 may route proxy connector 787 because that route included the lowest possible score. In addition, the proxy connector 787 may extend from the proxy object 746f and a duplicate of the proxy object 746d.

The processor 110 may reduce a size of the proxy diagram 700d. The processor 110 may reduce the size of the proxy diagram 700d to eliminate unused ports, rows, or columns. The processor 110 may identify empty rows 756a-c, empty columns 758a-b, or empty duplicates within the proxy diagram 700d. The empty rows 756a-c, the empty columns 758a-b, or the empty duplicates may include objects that are not connected to one of the proxy connectors 748a-d or 749a-b. Only a portion of the empty rows 756-c and the empty columns 758a-b are numbered in FIG. 7D for ease of illustration. Additionally, the processor 110 may remove the empty rows 756a-c, the empty columns 758a-b, or the empty duplicates to generate the proxy diagram 700e shown in FIG. 7E.

The processor 110 may generate the diagram 122 based on the proxy diagram 700e. For example, the processor 110 may generate the example diagram 122 shown in FIG. 6 based on the proxy diagram 700e shown in FIG. 7E.

With reference to FIGS. 1 and 6, in some embodiments, the processor 110 may determine a number of connectors connected to each of the graphical objects 636a-h. Additionally, the processor 110 may determine the number of connectors connected to each side of the graphical objects 636a-h. If a single connector is connected to a side of a particular graphical object, the processor 110 may connect the connector to a center point of the side. If multiple connectors are connected to a single side of a particular graphical object, the processor 110 may divide the side into a number of portions equal to the number of connectors and connect each connector to a center point of a different portion.

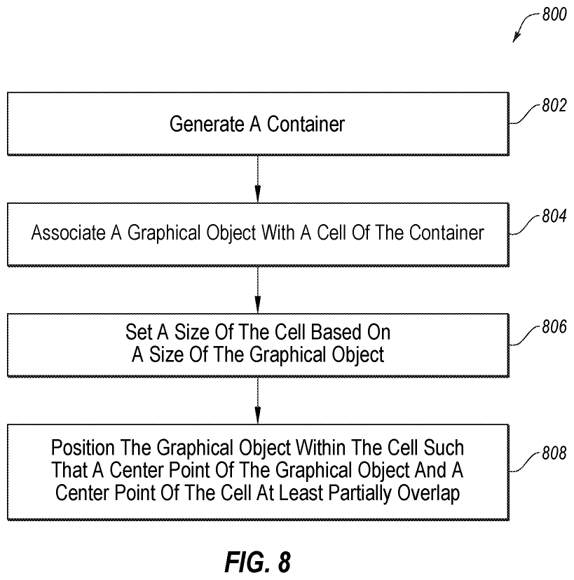

FIG. 8 illustrates a flowchart of an example method to facilitate placement of graphical objects within a container, in accordance with at least one embodiment described in the present disclosure. The method 800 may be performed by any suitable system, apparatus, or device with respect to placing graphical objects within a container. For example, the processors 110 and/or 130 of FIG. 1 may perform or direct performance of one or more of the operations associated with the method 800 with respect to placing graphical objects within a container. The method 800 may include one or more blocks 802, 804, 806, or 808. Although illustrated with discrete blocks, the steps and operations associated with one or more of the blocks of the method 800 may be divided into additional blocks, combined into fewer blocks, or eliminated, depending on the particular implementation.

At block 802, a container may be generated. The container may include a cell formatting for positioning graphical objects within the container. At block 804, a graphical object may be associated with a cell of the container. For example, the processor 110 may associate the graphical object 336a with the first cell 201a of the container 300.

At block 806, a size of the cell may be set based on a size of the graphical object. For example, the processor 110 may set the size of the cell 201 based on the size of the graphical object 336a. At block 808, the graphical object may be positioned within the cell such that a center point of the graphical object and a center point of the cell at least partially overlap. For example, the processor 110 may position the graphical object 336a within the first cell 201a such that the center point of the graphical object 336a and the center point of the first cell 201a at least partially overlap. (e.g., the graphical object 336a is centered within the first cell 201a).

Modifications, additions, or omissions may be made to the method 800 without departing from the scope of the present disclosure. For example, the operations of method 800 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

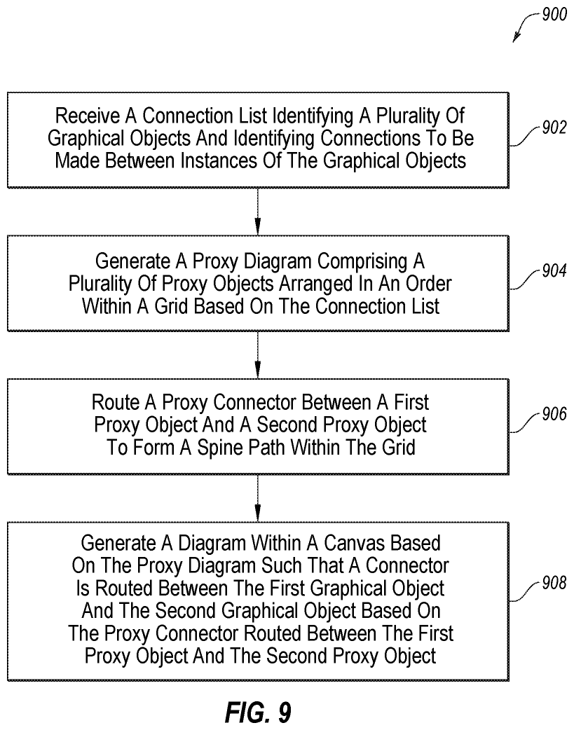

FIG. 9 illustrates a flowchart of an example method 900 to facilitate routing of connectors between graphical objects, in accordance with at least one embodiment described in the present disclosure. The method 900 may be performed by any suitable system, apparatus, or device with respect to routing connectors between graphical objects. For example, the processors 110 and/or 130 of FIG. 1 may perform or direct performance of one or more of the operations associated with the method 900 with respect to routing connectors between graphical objects. The method 900 may include one or more blocks 902, 904, 906, or 908. Although illustrated with discrete blocks, the steps and operations associated with one or more of the blocks of the method 900 may be divided into additional blocks, combined into fewer blocks, or eliminated, depending on the particular implementation.

At block 902, a connection list identifying a plurality of graphical objects and identifying connections to be made between instances of the graphical objects may be received. For example, the processor 110 may obtain the connection list 114 from the data storage 104, the canvas server 106, or the storage medium 112. At block 904, a proxy diagram comprising a plurality of proxy objects arranged in an order within a grid may be generated based on the connection list. For the example, the processor 110 may generate the proxy diagram 120 based on the connection list 114. Each of the proxy objects may correspond to a different graphical object to be included in a diagram in a canvas.

At block 906, a proxy connector may be routed between a first proxy object and a second proxy object to form a spine path within the grid. In some embodiments, the first proxy object may correspond to a first graphical object. In these and other embodiments, the second proxy object may correspond to a second graphical object. For example, the processor 110 may route the proxy connectors 748a-d between the proxy objects 746a-f. At block 908, a diagram may be generated within the canvas based on the proxy diagram such that a connector is routed between the first graphical object and the second graphical object based on the proxy connectors routed between the first proxy object and the second proxy object. For example, the processor 110 may generate the diagram 122 shown in FIG. 6 based on the example proxy diagram 700e shown in FIG. 7E.

Modifications, additions, or omissions may be made to the method 900 without departing from the scope of the present disclosure. For example, the operations of method 900 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

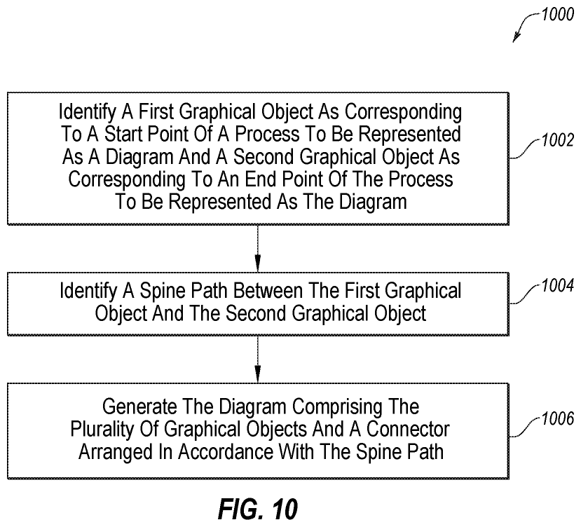

FIG. 10 illustrates a flowchart of an example method to facilitate placement of graphical objects within a diagram, in accordance with at least one embodiment described in the present disclosure. The method 1000 may be performed by any suitable system, apparatus, or device with respect to placing graphical objects within a diagram. For example, the processors 110 and/or 130 of FIG. 1 may perform or direct performance of one or more of the operations associated with the method 1000 with respect to placing graphical objects within a diagram. The method 1000 may include one or more blocks 1002, 1004, or 1006. Although illustrated with discrete blocks, the steps and operations associated with one or more of the blocks of the method 1000 may be divided into additional blocks, combined into fewer blocks, or eliminated, depending on the particular implementation.

At block 1002, a first graphical object may be identified as corresponding to a start point of a process to be represented as a diagram and a second graphical object may be identified as corresponding to an end point of the process to be represented as the diagram. For example, the processor 110 may identify the graphical object 636a as corresponding to the start point and may identify the graphical object 636f as corresponding to the end point. At block 1004, a spine path between the first graphical object and the second graphical object may be identified. In some embodiments, the spine path may include a number of graphical objects to create a path from the first graphical object to the second graphical object. For example, the processor 110 may identify the spine path 650 between the graphical objects 636a and 636f.

At block 1006, the diagram may be generated comprising the plurality of graphical objects and a connector arranged in accordance with the spine path. For example, the processor 110 may generate the diagram 122 shown in FIG. 6.

Modifications, additions, or omissions may be made to the method 1000 without departing from the scope of the present disclosure. For example, the operations of method 1000 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

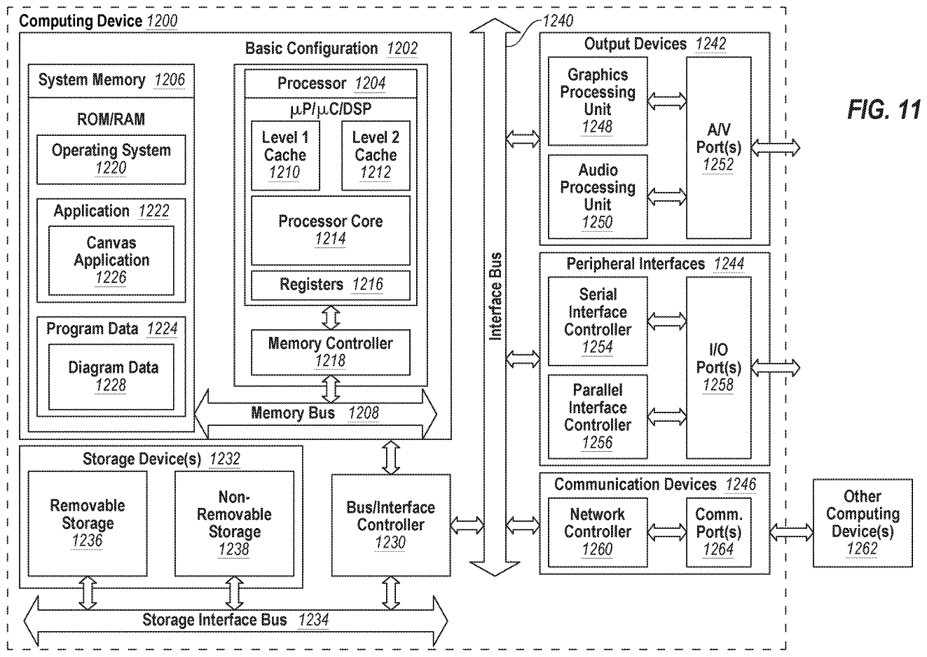

FIG. 11 is a block diagram illustrating an example computing device that is arranged to facilitate generation of a proxy diagram or a diagram, arranged in accordance with at least one embodiment described herein. The computing device 1200 may include, be included in, or otherwise correspond to either or both of the computing device 102 or the canvas server 106 of FIG. 1. In a basic configuration 1202, the computing device 1200 typically includes one or more processors 1204 and a system memory 1206. A memory bus 1208 may be used to communicate between the processor 1204 and the system memory 1206.

Depending on the desired configuration, the processor 1204 may be of any type including, but not limited to, a microprocessor (μP), a microcontroller (μC), a digital signal processor (DSP), or any combination thereof. The processor 1204 may include one or more levels of caching, such as a level one cache 1210 and a level two cache 1212, a processor core 1214, and registers 1216. The processor core 1214 may include an arithmetic logic unit (ALU), a floating point unit (FPU), a digital signal processing core (DSP Core), or any combination thereof. An example memory controller 1218 may also be used with the processor 1204, or in some implementations the memory controller 1218 may include an internal part of the processor 1204.

Depending on the desired configuration, the system memory 1206 may be of any type including volatile memory (such as RAM), nonvolatile memory (such as ROM, flash memory, etc.), or any combination thereof. The system memory 1206 may include an operating system 1220, one or more applications 1222, and program data 1224. The application 1222 may include a canvas application 1226 that is arranged to facilitate generation of a proxy diagram or a diagram. The program data 1224 may include diagram data 1228 (which may include, be included in, or otherwise correspond to the connection list 114, the input data 116, or both of FIG. 1) as is described herein. In some embodiments, the application 1222 may be arranged to operate with the program data 1224 on the operating system 1220 such that one or more methods may be provided as described herein.

The computing device 1200 may have additional features or functionality, and additional interfaces to facilitate communications between the basic configuration 1202 and any involved devices and interfaces. For example, a bus/interface controller 1230 may be used to facilitate communications between the basic configuration 1202 and one or more data storage devices 1232 via a storage interface bus 1234. The data storage devices 1232 may be removable storage devices 1236, non-removable storage devices 1238, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 1206, the removable storage devices 1236, and the non-removable storage devices 1238 (which may include, be included in, or otherwise correspond to one or more of the storage mediums 112 or 128 or the data storage 104 of FIG. 1) are examples of computer storage media or non-transitory computer-readable media. Computer storage media or non-transitory computer-readable media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other non-transitory medium which may be used to store the desired information and which may be accessed by the computing device 1200. Any such computer storage media or non-transitory computer-readable media may be part of the computing device 1200.

The computing device 1200 may also include an interface bus 1240 to facilitate communication from various interface devices (e.g., output devices 1242, peripheral interfaces 1244, and communication devices 1246) to the basic configuration 1202 via the bus/interface controller 1230. The output devices 1242 include a graphics processing unit 1248 and an audio processing unit 1250, which may be configured to communicate to various external devices such as a display (e.g., display 126 of FIG. 1) or speakers via one or more A/V ports 1252. The connection list, input data, diagrams, or proxy diagrams generated by the canvas application 1226 may be output through the graphics processing unit 1248 to such a display. The peripheral interfaces 1244 include a serial interface controller 1254 or a parallel interface controller 1256, which may be configured to communicate with external devices such as input devices (e.g., keyboard, mouse, pen, voice input device, touch input device, etc.), sensors, or other peripheral devices (e.g., printer, scanner, etc.) via one or more I/O ports 1258. Such input devices may be operated by a user to provide input to the canvas application 1226, which may be effective to generate, modify, or otherwise interact with visual representations and/or charts within the canvas application 1226. The communication devices 1246 include a network controller 1260, which may be arranged to facilitate communications with one or more other computing devices 1262 over a network communication link via one or more communication ports 1264.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 1200 may be implemented as a portion of a small-form factor portable (or mobile) electronic device such as a smartphone, a personal data assistant (PDA) or an application-specific device. The computing device 1200 may also be implemented as a personal computer including tablet computer, laptop computer, and/or non-laptop computer configurations, or a server computer including both rack-mounted server computer and blade server computer configurations.

Embodiments described herein may be implemented using computer-readable media for carrying or having computer-executable instructions or data structures stored thereon. Such computer-readable media may be any available media that may be accessed by a general-purpose or special-purpose computer. By way of example, such computer-readable media may include non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method to facilitate placement of graphical objects within a container, the method comprising:
generating the container, the container comprising a cell formatting for positioning graphical objects within the container;
associating a graphical object with a cell of the container;
setting a size of the cell based on a size of the graphical object; and
positioning the graphical object within the cell such that a center point of the graphical object and a center point of the cell at least partially overlap.

2. The method of claim 1 further comprising setting a size of the container based on the size of the cell to maintain a particular distance between a boundary of the cell and a boundary of the container.

3. The method of claim 1, wherein the graphical object comprises a first graphical object and the method further comprises:
receiving input effective to place a second graphical object within the container;
generating an additional cell within the container based on the input, wherein the additional cell comprises a size based on at least one of the size of the first graphical object or a size of the second graphical object; and
positioning the second graphical object within the additional cell such that a center point of the second graphical object and a center point of the additional cell at least partially overlap.

4. The method of claim 3 further comprising:
receiving input effective to adjust the size of the first graphical object such that at least one dimension of the first graphical object is greater than a corresponding dimension of the second graphical object;
automatically adjusting the size of the cell based on the adjusted size of the first graphical object; and
automatically adjusting a size of the container based on the adjusted size of the cell to maintain a particular distance between a boundary of the cell and a boundary of the container.

5. The method of claim 3, wherein the size of the additional cell is based on the size of the second graphical object, the method further comprising:
adjusting the size of the cell based on the size of the second graphical object; and
at least one of:
adjusting a location of the cell within the container to maintain a particular distance between a boundary of the cell and a boundary of the additional cell; or
setting a location of the additional cell to maintain the particular distance between the boundary of the cell and the boundary of the additional cell.

6. The method of claim 6 further comprising:
receiving input effective to adjust a dimension of the particular distance between the boundary of the cell and the boundary of the additional cell; and
adjusting a location of at least one of the cell or the additional cell to maintain the adjusted dimension of the particular distance.

7. The method of claim 7 further comprising setting a size of the container based on at least one of:
the adjusted dimension of the particular distance to maintain the adjusted particular distance between a boundary of the container and the boundary of the cell or the boundary of the additional cell; or
the adjusted location of the at least one of the cell or the additional cell to maintain the adjusted particular distance between the boundary of the container and the boundary of the cell or the boundary of the additional cell.

8. The method of claim 1, wherein the graphical object comprises a first graphical object and the method further comprises:
receiving input effective to hover a second graphical object over a particular location in the container; and
displaying a drop zone indicator at the particular location in the container, the drop zone indicator comprising at least one of:
a first indicium indicating placement of the second graphical object at the particular location will cause a new cell to be created within the container; or
a second indicium indicating placement of the second graphical object at the particular location will cause the second graphical object to be positioned within a pre-existing cell.

9. The method of claim 1, wherein the graphical object comprises a first graphical object, the cell comprises a first cell, and the method further comprises:
receiving a first input effective to place a second graphical object within the container;
generating a second cell within the container based on the first input, wherein the second cell comprises a size based on a size of at least one of the first graphical object or the second graphical object;
positioning the second graphical object within the second cell such that a center point of the second graphical object and a center point of the second cell at least partially overlap and such that the first graphical object and the second graphical object form a row or a column within the container;
receiving a second input effective to place a third graphical object within the container;
generating a third cell within the container based on the second input, wherein the third cell comprises a size based on at least one of the size of the first graphical object, the size of the second graphical object, or a size of the third graphical object; and
positioning the third graphical object within the third cell such that a center point of the third graphical object and a center point of the third cell at least partially overlap and such that the third graphical object and at least one of the first graphical object or the second graphical object form a row or a column within the container.

10. A method to facilitate routing of connectors between graphical objects, the method comprising:
receiving a connection list identifying a plurality of graphical objects and identifying connections to be made between instances of the graphical objects;
generating a proxy diagram comprising a plurality of proxy objects arranged in an order within a grid based on the connection list, each of the proxy objects corresponding to a different graphical object to be included in a diagram in a canvas;
routing a proxy connector between a first proxy object and a second proxy object to form a spine path within the grid, the first proxy object corresponding to a first graphical object and the second proxy object corresponding to a second graphical object; and
generating the diagram within the canvas based on the proxy diagram such that a connector is routed between the first graphical object and the second graphical object based on the proxy connector routed between the first proxy object and the second proxy object.

11. The method of claim 10 further comprising:
identifying the first graphical object corresponds to a start point of the diagram and the second graphical object corresponds to an end point of the diagram;
determining the first proxy object corresponds to the first graphical object and the second proxy object corresponds to the second graphical object; and
identifying a path between the first proxy object and the second proxy object comprising a number of proxy objects to create a route from the first proxy object to the second proxy object, wherein the spine path of the grid represents the route between the first proxy object and the second proxy object.

12. The method of claim 10 further comprising creating a duplicate of the first proxy object, the duplicate first proxy object positioned proximate to the first proxy object and forming an additional row or column proximate to the first proxy object in the grid, the duplicate first proxy object representing a port for subsequent proxy connectors to connect to the first proxy object.

13. The method of claim 12, wherein the creating the duplicate of the first proxy object comprises creating duplicates of the proxy objects that are in a same row or a same column as the first proxy object.

14. The method of claim 10 wherein the generating the diagram within the canvas is based on the proxy diagram such that the connector is routed between the first graphical object and the second graphical object comprises:
determining a number of connectors connected to the first proxy object;
dividing a dimension of the first graphical object into portions based on the number of connectors;
identifying a center point for each portion of the dimension of the first graphical object; and
connecting the connector to a boundary of the first graphical object at the center point of a corresponding portion of the dimension.

15. The method of claim 10, wherein:
the proxy connector comprises a first proxy connector;
the connector comprises a first connector; and
the method further comprises:
determining a third proxy object is to be connected to the spine path of the proxy diagram; and
routing a second proxy connector between a third proxy object and the spine path within the grid, the third proxy object corresponding to a third graphical object.

16. The method of claim 15, wherein:
the third proxy object corresponds to a third graphical object; and
the diagram is generated within the canvas based on the proxy diagram such that a second connector is routed between the third graphical object and at least one of the first graphical object or the second graphical object based on the second proxy connector being routed between the third proxy object and the spine path.

17. A method to facilitate placement of graphical objects within a diagram, the method comprising:
identifying a first graphical object as corresponding to a start point of a process to be represented as a diagram and a second graphical object as corresponding to an end point of the process to be represented as the diagram;
identifying a spine path between the first graphical object and the second graphical object, the spine path comprising a number of graphical objects to create a path from the first graphical object to the second graphical object; and
generating the diagram comprising the number of graphical objects and a connector arranged in accordance with the spine path.

18. The method of claim 17 further comprising:
identifying a third graphical object that is not included in the spine path; and
identifying an additional path of graphical objects between the third graphical object and the spine path, the additional path comprising a fewest number of graphical objects to connect the third graphical object to the spine path, wherein the plurality of graphical objects and an additional connector are arranged in the diagram in accordance with the additional path.

19. The method of claim 17, wherein the generating the diagram comprising the plurality of graphical objects and the connector comprises:
generating a container comprising a cell formatting for positioning the plurality of graphical objects within the container;
associating the plurality of graphical objects with different cells of the container in accordance with the spine path;
setting a size of the different cells based on a size of a corresponding graphical object; and
positioning the plurality of graphical objects within the corresponding cells such that a center point of each of the graphical objects and a center point of the corresponding cells at least partially overlap.

20. The method of claim 17, wherein the identifying the spine path between the first graphical object and the second graphical object comprises:
generating a plurality of potential spine paths between the first graphical object and the second graphical object, each of the potential spine paths representing a potential sequence of steps to go from the start point to the end point of the diagram and each of the potential spine paths comprising a number of intermediary graphical objects; and
comparing the number of intermediary graphical objects within the plurality of potential spine paths to each other, wherein the potential spine path that includes the fewest number of intermediary graphical objects relative to the other potential spine paths is identified as the spine path.
